(19) United States
(12) Patent Application Publication
(10) Pub. No.: US 2025/0024218 A1
(43) Pub. Date: Jan. 16, 2025

(54) PERSONALIZATION OF SPATIAL HEARING FOR AUGMENTED REALITY/VIRTUAL REALITY HEADSETS

(71) Applicant: GOOGLE LLC, Mountain View, CA (US)

(72) Inventors: Rajeev Nongpiur, Mountain View, CA (US); Dongeek Shin, San Jose, CA (US); Sinan Hersek, Seattle, WA (US); Jason Kerr, Oakland, CA (US)

(21) Appl. No.: 18/351,988

(22) Filed: Jul. 13, 2023

(51) Int. Cl. H04S 7/00

(52) U.S. Cl. CPC H04S 7/304; G06F 3/013; H04S 2420/01

(57) ABSTRACT

Techniques include providing a user with a set of loudspeakers on a sphere and playing back sound from the set of loudspeakers one at a time. For each loudspeaker, the user points in a direction at which the user perceives the sound. The HRTF corresponding to a new direction based on the perceived direction is used instead, or the original HRTF at the perceived direction is used. In some implementations, the new direction is obtained from the perceived direction via a barycentric mapping. In some implementations, a difference between the new direction and the perceived direction is equal to a difference between the perceived direction and the original direction.

### TECHNICAL FIELD

This description relates in general to audio, specifically binaurally rendered spatial audio.

### BACKGROUND

A sound field generated at an array of virtual sound sources can reproduce the effect of a sound source from any vantage point relative to a listener. Such a sound field may be decoded and used in the delivery of audio through headphone speakers in, e.g., Virtual Reality (VR) and/or augmented reality (AR) systems.

### SUMMARY

This disclosure relates to a calibration process for binaural rendering of spatial audio through headphone speakers. In spatial audio, the listener should be able to identify a direction from which a sound originates. In binaural rendering of spatial audio, an audio signal is multiplied in the frequency domain by a head-related transfer function (HRTF), which depends on the angular position of a virtual loudspeaker from which the sound appears to have originated. The HRTF also depends on the particular geometry and density of the listener's head. Accordingly, the calibration process involves personalizing HRTFs for the listener, which in turn involves using specialized equipment in an anechoic chamber, which is impractical for a production device. An alternative way of calibrating spatial audio for a user involves prompting the listener to identify a direction from which the listener perceives sound from an original direction to have originated. If this perceived direction differs from the original direction, a new direction is identified that is based on the perceived direction; the HRTF from this new direction is used in place of the original HRTF for binaural rendering of sound. In some examples, the new direction is found via a barycentric mapping.

In one general aspect, a method includes binaurally rendering a first audio signal for a listener using a first head-related transfer function (HRTF) corresponding to a first angular position of a virtual loudspeaker with respect to a position of the listener, the first audio signal representing sound emanating from the virtual loudspeaker. The method also includes receiving an indication from the listener that the first audio signal is perceived to have originated from a second angular position with respect to the position of the listener. The method further includes, in response to the indication, determining a second HRTF corresponding to a third angular position with respect to the position of the listener, the third angular position being based on the second angular position. The method further includes binaurally rendering a second audio signal for the listener using the second HRTF.

In another general aspect, a computer program product comprising a nontransitive storage medium, the computer program product including code that, when executed by processing circuitry, causes the processing circuitry to perform a method. The method includes binaurally rendering a first audio signal for a listener using a first head-related transfer function (HRTF) corresponding to a first angular position of a virtual loudspeaker with respect to a position of the listener, the first audio signal representing sound emanating from the virtual loudspeaker. The method also includes receiving an indication from the listener that the first audio signal is perceived to have originated from a second angular position with respect to the position of the listener. The method further includes, in response to the indication, determining a second HRTF corresponding to a third angular position with respect to the position of the listener, the third angular position being based on the second angular position. The method further includes binaurally rendering a second audio signal for the listener using the second HRTF.

In another general aspect, an electronic apparatus configured to render sound fields in cars of a listener includes memory and controlling circuitry coupled to the memory. The controlling circuitry is configured to binaurally render a first audio signal for a listener using a first head-related transfer function (HRTF) corresponding to a first angular position of a virtual loudspeaker with respect to a position of the listener, the first audio signal representing sound emanating from the virtual loudspeaker. The controlling circuitry is also configured to receive an indication from the listener that the first audio signal is perceived to have originated from a second angular position with respect to the position of the listener. The controlling circuitry is further configured to, in response to the indication, determine a second HRTF corresponding to a third angular position with respect to the position of the listener, the third angular position being based on the second angular position. The controlling circuitry is further configured to binaurally render a second audio signal for the listener using the second HRTF.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram illustrating an example calibration process for spatial audio.

FIG. 2 is a flow chart illustrating an example calibration process for spatial audio.

FIG. 3 is a diagram illustrating an example electronic environment for performing a calibration process for spatial audio.

FIG. 4 is a flow chart illustrating an example method for performing a calibration process for spatial audio.

### DETAILED DESCRIPTION

To deliver audio through headphone speakers, multiplication of the sound field in the frequency domain with head-related transfer functions (HRTFs) (left and right) is performed; this is known as binaural rendering. An HRTF is a response that characterizes how an ear receives a sound from a point in space. As sound strikes the listener, the size and shape of the head, ears, ear canal, density of the head, size and shape of nasal and oral cavities, and/or so forth can transform the sound and affect how it is perceived by boosting some frequencies and attenuating others.

At least one technical problem is that standard (e.g., non-personalized) HRTFs used for binaural rendering may not be defined precisely in a personalized fashion HRTFs for every listener. Known systems are not capable of reasonably obtaining personalized HRTFs. Personalized HRTFs can be obtained by defining HRTFs for a user using specialized equipment in an anechoic chamber, which is impractical for a production device.

At least one technical solution is directed to a calibration process playing back sound from a virtual set of loudspeakers one loudspeaker at a time. For a loudspeaker, the user indicates a direction at which the user perceives the sound. The HRTF corresponding to a new direction based on the perceived direction is used instead, or the original HRTF at the perceived direction is used. In some implementations, the new direction is obtained from the perceived direction via a barycentric mapping. In some implementations, a difference between the new direction and the perceived direction is equal to a difference between the perceived direction and the original direction.

In some implementations, the set of loudspeakers are placed at the vertices of a cube inscribed in a sphere with the listener at the center. The calibration process then entails determining the HRTF corresponding to each vertex, one at a time.

The technical solution can improve the hearing experience for the user by using HRTFs that are better aligned with the response of the listener.

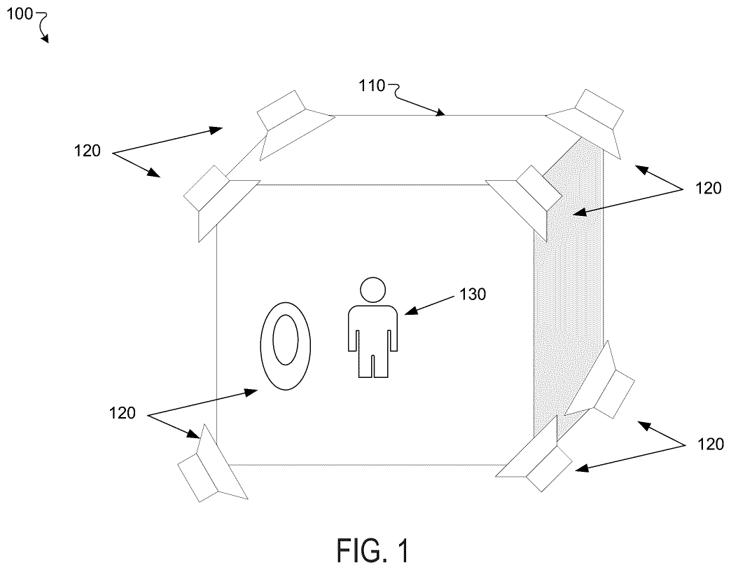

FIG. 1 is a diagram illustrating an example calibration process 100 for spatial audio. As shown in FIG. 1, a listener 130 is at the center of a cube 110 (which itself is, in some implementations, inscribed in a sphere). At each of the eight vertices of the cube there is a virtual loudspeaker 120. Each virtual loudspeaker 120 is pointed in an original direction toward the listener 130, e.g. located at an angular position with respect to the listener 130.

For at least one of the loudspeakers 120, a sound is emitted as if it emanates from that loudspeaker and is binaurally rendered using an original HRTF. The listener 130 is then prompted to indicate a perceived direction from which the sound is perceived by the listener 130 to have originated. If the perceived direction differs from the original direction, then a new HRTF is selected from a new angular position that is based on the perceived direction and subsequent binaural rendering for this loudspeaker uses this HRTF. Alternatively, the original HRTF may be used with audio emanating from a virtual loudspeaker at the new angular position. In some implementations, the new angular position is determined via a barycentric mapping.

The above-described calibration process for one virtual loudspeaker may be repeated for the other virtual loudspeakers 120. It is noted that, in some implementations, the virtual loudspeakers can be in any arrangement and is not limited to the cube arrangement described above.

When the virtual loudspeakers are arranged in a cube, the resulting audio signal may be represented as a first order ambisonic signal. Other symmetrical arrangements with more vertices may be used to form a signal represented by higher-order (e.g., second order) ambisonic signals.

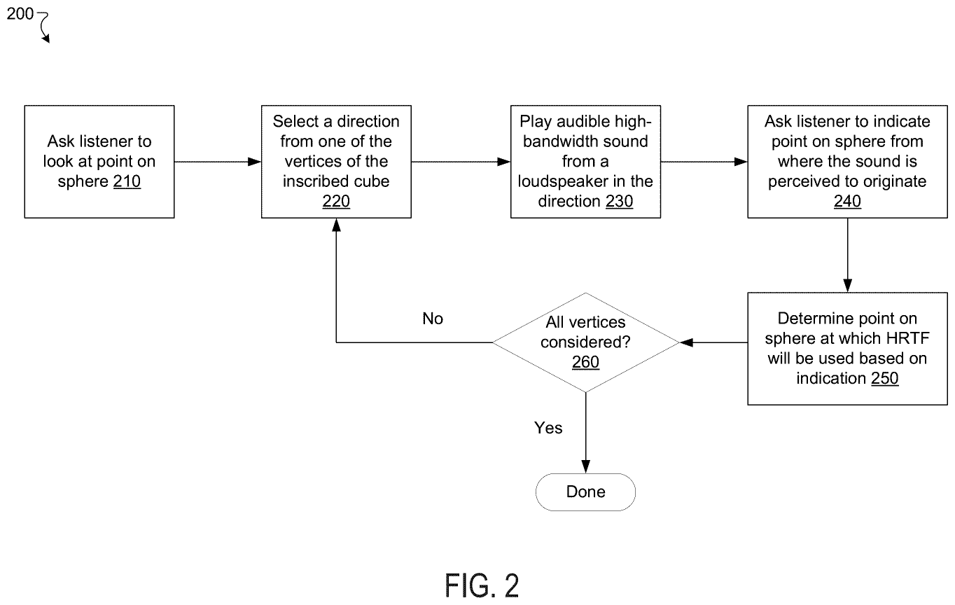

FIG. 2 is a flow chart illustrating an example calibration process 200 for spatial audio.

At 210, processing circuitry prompts a listener to look at a point on a sphere (e.g., in a direction toward an angular position). At 220, the processing circuitry selects a virtual loudspeaker (e.g., an angular position) from one of the vertices of an inscribed cube with the listener at the center. At 230, the processing circuitry plays an audible, high-bandwidth sound as if were emanating from the selected virtual loudspeaker. An example of a high-bandwidth sound would be a series of clicks.

At 240, the processing circuitry prompts the listener to indicate a point on the sphere (e.g., an angular position) from which the sound is perceived to originate. At 250, if the perceived angular position differs from the angular position of the virtual loudspeaker, then the processing circuitry determines a new point on the sphere (e.g., a new angular position) at which the HRTF will be used in binaural rendering. The new angular position is based on the perceived angular position. In some implementations, the new angular position is found via a barycentric mapping. In some implementations, the difference between the new angular position and the perceived angular position is equal to a difference between the perceived angular position and the original angular position.

At 260, it is determined whether all vertices of the cube have been considered (e.g., have taken part in the calibration process). If not all vertices have been considered, then one of the vertices not considered is selected and the calibration process is repeated from 220.

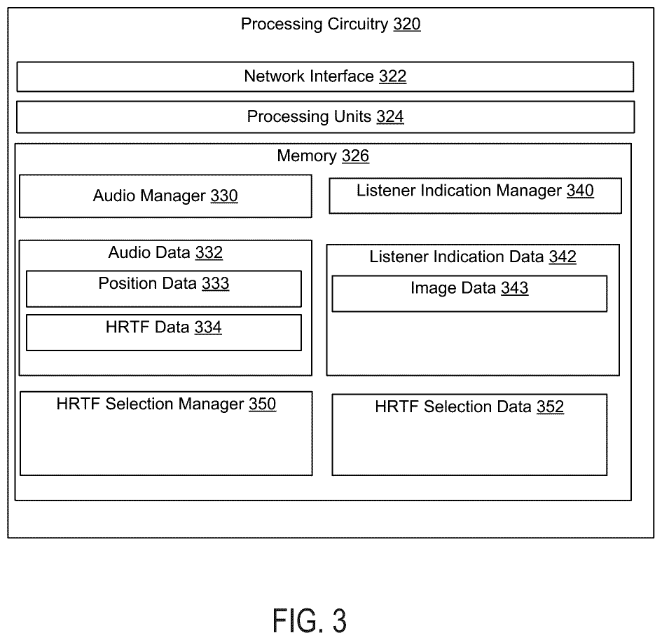

FIG. 3 is a diagram illustrating an example electronic environment for performing a calibration process for spatial audio. The processing circuitry 320 includes a network interface 322, one or more processing units 324, and non transitory memory (storage medium) 326.

In some implementations, one or more of the components of the processing circuitry 320 can be, or can include processors (e.g., processing units 324) configured to process instructions stored in the memory 326 as a computer program product. Examples of such instructions as depicted in FIG. 3 include audio manager 530, listener indication manager 340, and HRTF selection manager 350. Further, as illustrated in FIG. 3, the memory 326 is configured to store various data, which is described with respect to the respective services and managers that use such data.

The audio manager 330 is configured to binaurally render spatial audio for a listener using audio data 332. The audio data 332 includes position data 333 representing a virtual loudspeaker position and HRTF data 334 representing the HRTF for the listener at that position. The HRTF data 334 includes left HRTF data and right HRTF data for the left and right cars, respectively. The audio data 332 further includes audio data representing sounds to be played in the listener's headphones upon binaural rendering.

The listener indication manager 340 is configured to prompt the listener for an angular position of a perceived origin of the sound being binaurally rendered. The listener indication manager is also configured to record a perceived angular position in listener indication data 342 based on the indication. In some implementations, the listener makes an indication of the perceived angular position by gazing in the direction of the angular position, and an eye-tracking camera (e.g., on the frame of a smartglasses device) captures the image of the eye in image data 343.

The HRTF selection manager 350 is configured to determine a new angular position from which to use an HRTF for binaural rendering, based on the listener indication data 342 (e.g., the perceived angular position indicated by the listener). In some implementations, the HRTF selection manager 350 performs a barycentric mapping to determine the new angular position. In some implementations, the HRTF selection manager 350 determines the new angular position from the difference between the new angular position and the perceived angular position is equal to the difference between the perceived angular position and the original angular position. The HRTF selection data 352 represents the new angular position and the HRTF corresponding to the new angular position. The audio manager 330 is then configured to binaurally render audio using the HRTF at the new angular position.

The components (e.g., modules, processing units 324) of processing circuitry 320 can be configured to operate based on one or more platforms (e.g., one or more similar or different platforms) that can include one or more types of hardware, software, firmware, operating systems, runtime libraries, and/or so forth. In some implementations, the components of the processing circuitry 320 can be configured to operate within a cluster of devices (e.g., a server farm). In such an implementation, the functionality and processing of the components of the processing circuitry 320 can be distributed to several devices of the cluster of devices.

The components of the processing circuitry 320 can be, or can include, any type of hardware and/or software configured to process private data from a wearable device in a split-compute architecture. In some implementations, one or more portions of the components shown in the components of the processing circuitry 320 in FIG. 3 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processing circuitry 320 can be, or can include, a software module configured for execution by at least one processor (not shown) to cause the processor to perform a method as disclosed herein. In some implementations, the functionality of the components can be included in different modules and/or different components than those shown in FIG. 3, including combining functionality illustrated as two components into a single component.

The network interface 322 includes, for example, wireless adaptors, and the like, for converting electronic and/or optical signals received from the network to electronic form for use by the processing circuitry 320. The set of processing units 324 include one or more processing chips and/or assemblies. The memory 326 includes both volatile memory (e.g., RAM) and non-volatile memory, such as one or more ROMs, disk drives, solid state drives, and the like. The set of processing units 324 and the memory 326 together form processing circuitry, which is configured and arranged to carry out various methods and functions as described herein.

Although not shown, in some implementations, the components of the processing circuitry 320 (or portions thereof) can be configured to operate within, for example, a data center (e.g., a cloud computing environment), a computer system, one or more server/host devices, and/or so forth. In some implementations, the components of the processing circuitry 320 (or portions thereof) can be configured to operate within a network. Thus, the components of the processing circuitry 320 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the processing circuitry 320 can be, or can include, processors configured to process instructions stored in a memory. For example, audio manager 330 (and/or a portion thereof), listener indication manager 340 (and/or a portion thereof), and HRTF selection manager 350 (and/or a portion thereof) are examples of such instructions.

In some implementations, the memory 326 can be any type of memory such as a random-access memory, a disk drive memory, flash memory, and/or so forth. In some implementations, the memory 326 can be implemented as more than one memory component (e.g., more than one RAM component or disk drive memory) associated with the components of the processing circuitry 320. In some implementations, the memory 326 can be a database memory. In some implementations, the memory 326 can be, or can include, a non-local memory. For example, the memory 326 can be, or can include, a memory shared by multiple devices (not shown). In some implementations, the memory 326 can be associated with a server device (not shown) within a network and configured to serve the components of the processing circuitry 320. As illustrated in FIG. 3, the memory 326 is configured to store various data, including audio data 332, listener indication data 342, and HRTF selection data 352.

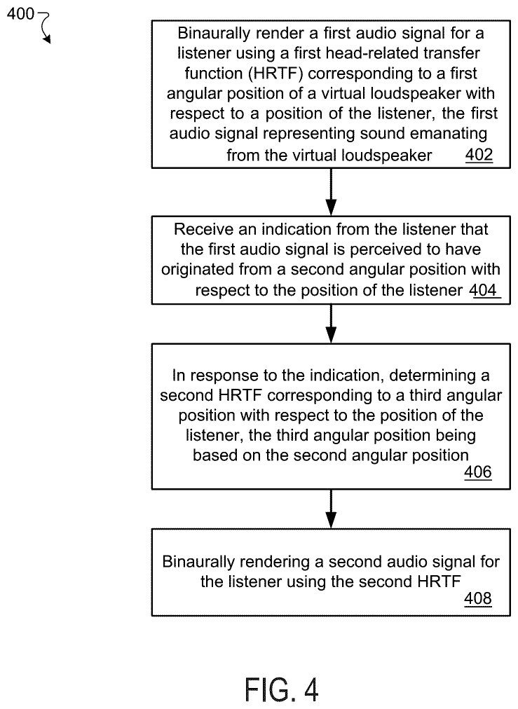

FIG. 4 is a flow chart illustrating an example method 400 for performing a calibration process for spatial audio. The method 400 may be performed using the processing circuitry 320 of FIG. 3.

At 402, the audio manager 330 binaurally renders a first audio signal for a listener using a first head-related transfer function (HRTF) corresponding to a first angular position of a virtual loudspeaker with respect to a position of the listener, the first audio signal representing sound emanating from the virtual loudspeaker.

At 404, the listener indication manager 340 receives an indication from the listener that the first audio signal is perceived to have originated from a second angular position with respect to the position of the listener.

At 406, the HRTF selection manager 350, in response to the indication, determines a second HRTF corresponding to a third angular position with respect to the position of the listener, the third angular position being based on the second angular position.

At 408, the audio manager 330 binaurally renders a second audio signal for the listener using the second HRTF.

Specific structural and functional details disclosed herein are merely representative for purposes of describing example embodiments. Example embodiments, however, may be embodied in many alternate forms and should not be construed as limited to only the embodiments set forth herein.

The terminology used herein is for the purpose of describing particular embodiments only and is not intended to be limiting of the embodiments. As used herein, the singular forms “a.” “an,” and “the” are intended to include the plural forms as well, unless the context clearly indicates otherwise. It will be further understood that the terms “comprises,” “comprising.” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled.” “connected,” or “responsive” to, or “on,” another element, it can be directly coupled, connected, or responsive to, or on, the other element, or intervening elements may also be present. In contrast, when an element is referred to as being “directly coupled.” “directly connected,” or “directly responsive” to, or “directly on,” another element, there are no intervening elements present. As used herein the term “and/or” includes any and all combinations of one or more of the associated listed items.

Spatially relative terms, such as “beneath,” “below.” “lower,” “above,” “upper.” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 70 degrees or at other orientations) and the spatially relative descriptors used herein may be interpreted accordingly.

Example embodiments of the concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

What is claimed is:

1. A method, comprising:
binaurally rendering a first audio signal for a listener using a first head-related transfer function (HRTF) corresponding to a first angular position of a virtual loudspeaker with respect to a position of the listener, the first audio signal representing sound emanating from the virtual loudspeaker;
receiving an indication from the listener that the first audio signal is perceived to have originated from a second angular position with respect to the position of the listener;
in response to the indication, determining a second HRTF corresponding to a third angular position with respect to the position of the listener, the third angular position being based on the second angular position; and
binaurally rendering a second audio signal for the listener using the second HRTF.

2. The method as in claim 1, wherein the third angular position is a barycentric mapping of the second angular position.

3. The method as in claim 1, wherein a difference between the third angular position and the second angular position is equal to a difference between the second angular position and the first angular position.

4. The method as in claim 1, wherein the first angular position is at a vertex of a cube inscribed in a sphere.

5. The method as in claim 4, wherein the first angular position is one of eight angular positions representing eight vertices of the cube and the second audio signal is represented as a first order ambisonic signal.

6. The method as in claim 1, wherein receiving the indication includes:
obtaining an image from an eye-tracking camera of an eye of the listener gazing at the second angular position.

7. The method as in claim 1, wherein the first audio signal includes an audible, high-bandwidth sound.

8. A computer program product comprising a nontransitory storage medium, the computer program product including code that, when executed by processing circuitry, causes the processing circuitry to perform a method, the method comprising:
binaurally rendering a first audio signal for a listener using a first head-related transfer function (HRTF) corresponding to a first angular position of a virtual loudspeaker with respect to a position of the listener, the first audio signal representing sound emanating from the virtual loudspeaker;
receiving an indication from the listener that the first audio signal is perceived to have originated from a second angular position with respect to the position of the listener;
in response to the indication, determine a second HRTF corresponding to a third angular position with respect to the position of the listener, the third angular position being based on the second angular position; and
binaurally rendering a second audio signal for the listener using the second HRTF.

9. The computer program product as in claim 8, wherein the third angular position is a barycentric mapping of the second angular position.

10. The computer program product as in claim 8, wherein a difference between the third angular position and the second angular position is equal to a difference between the second angular position and the first angular position.

11. The computer program product as in claim 8, wherein the first angular position is at a vertex of a cube inscribed in a sphere.

12. The computer program product as in claim 11, wherein the first angular position is one of eight angular positions representing eight vertices of the cube and the second audio signal is represented as a first order ambisonic signal.

13. The computer program product as in claim 8, wherein receiving the indication includes:
obtaining an image from an eye-tracking camera of an eye of the listener gazing at the second angular position.

14. The computer program product as in claim 8, wherein the first audio signal includes an audible, high-bandwidth sound.

15. An electronic apparatus configured to render sound fields in ears of a listener, the electronic apparatus comprising:
memory; and
processing circuitry coupled to the memory, the processing circuitry being configured to:
binaurally render a first audio signal for a listener using a first head-related transfer function (HRTF) corresponding to a first angular position of a virtual loudspeaker with respect to a position of the listener, the first audio signal representing sound emanating from the virtual loudspeaker;
receive an indication from the listener that the first audio signal is perceived to have originated from a second angular position with respect to the position of the listener;
in response to the indication, determine a second HRTF corresponding to a third angular position with respect to the position of the listener, the third angular position being based on the second angular position; and
binaurally render a second audio signal for the listener using the second HRTF.

16. The electronic apparatus as in claim 15, wherein the third angular position is a barycentric mapping of the second angular position.

17. The electronic apparatus as in claim 15, wherein a difference between the third angular position and the second angular position is equal to a difference between the second angular position and the first angular position.

18. The electronic apparatus as in claim 15, wherein the first angular position is at a vertex of a cube inscribed in a sphere.

19. The electronic apparatus as in claim 18, wherein the first angular position is one of eight angular positions representing eight vertices of the cube and the second audio signal is represented as a first order ambisonic signal.

20. The electronic apparatus as in claim 15, wherein the processing circuitry configured to receive the indication is further configured to:
obtain an image from an eye-tracking camera of an eye of the listener gazing at the second angular position.
